(19) United States
(12) Patent Application Publication
(10) Pub. No.: US 2005/0201336 A1
(43) Pub. Date: Sep. 15, 2005

(54) System and method for providing codec information in a mobile communication network

(75) Inventor: Byoung-Yeul Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/995,434

(22) Filed: Nov. 24, 2004

(30) Foreign Application Priority Data
Mar. 10, 2004 (KR) 2004-16232

(51) Int. Cl. H04B 7/216; H04J 3/00

(52) U.S. Cl. 370/335; 370/342

(57) ABSTRACT

A method and system for improving a codec negotiation procedure so that a call setup time can be reduced in an International Mobile Telecommunications (IMT)-2000 network. A media gateway (MGW) connects a radio network controller (RNC) of a radio access network accessed by at least one user equipment (UE) to another network. A mobile switching center (MSC) server controls connections of the RNC and the MGW, determines the codec information for the UE through codec negotiation when the UE makes a call setup request, and directly provides the determined codec information to the MGW through an additional request message based on a MEGACO interface so that the codec information can be used when the MGW sets up a path associated with a requested call.

### PRIORITY

This application claims the benefit under 35 U.S.C. § 119(a) of an application entitled “METHOD FOR PROVIDING CODEC INFORMATION IN MOBILE TELECOMMUNICATION NETWORK”, filed in the Korean Intellectual Property Office on Mar. 10, 2004 and assigned Serial No. 2004-16232, the entire contents of which are incorporated herein by reference.

### BACKGROUND OF THE INVENTION

1. Field of the Invention

The present invention relates to a mobile communication network. More particularly, the present invention relates to a system and method for improving a codec negotiation procedure so that a call setup time can be reduced in an International Mobile Telecommunications (IMT)-2000 network.

2. Description of the Related Art

The third generation mobile communication system called International Mobile Telecommunications (IMT)-2000 uses code division multiple access (CDMA) technology, and provides services so that users of mobile phones or terminals can transmit a packet-based text, digitized voice or video and multimedia data at a data rate of 2 Mbps or more from anywhere in the world. This third generation mobile communication system is classified as an asynchronous wideband code division multiple access (WCDMA) system which is adopted as the European standard and a synchronous CDMA-2000 system which is adopted as the American standard.

An IMT-2000 network is divided into a control plane and a user plane. The user plane is responsible for delivering voice and user data traffic, controlling a transmission rate of voice data in the course of communication, a time alignment function, an error event processing function, and so on. The control plane is associated with a signalling function for controlling the flow of voice and data traffic. In a call setup procedure using the IMT-2000 network, one of the important parts is codec negotiation. The codec negotiation sets codec information to be used and more particularly sets transmission rate information indicating a voice compression rate for respective nodes of a call-related user plane.

The codec negotiation in the call setup procedure between an originating side and a terminating side of the conventional IMT-2000 network is performed through a radio access network (RAN). That is, the terminating side's switching center provides codec information determined by the codec negotiation to the RAN through the originating side's switching center. Moreover, the originating side's RAN sequentially provides the codec information to gateway nodes of the call-related user plane.

Problems of the conventional codec negotiation procedure as described above are as follows.

1. A gateway node of the user plane coupled to a fixed telephone network, that is, a public switched telephone network (PSTN), cannot receive the codec information according to the conventional codec negotiation procedure because no RAN coupled to the PSTN is provided. Thus, the gateway node coupled to the PSTN must use only preset default codec information.

2. As the codec information is delivered to gateway nodes via the RAN, resources must be assigned so that a corresponding procedure can be performed. Therefore, waste of system resources, call setup time delay and overhead due to an additional protocol initialization operation can be incurred.

3. Because resources must be assigned so that the codec information can be transmitted and received between the gateway nodes of the user plane, a waste of system resources and delay due to the protocol initialization operation can be incurred.

### SUMMARY OF THE INVENTION

Therefore, the present invention has been made in view of the above problems. It is an object of the present invention to provide a method that can allow a mobile switching center (MSC) server to simultaneously provide codec information to a radio network controller (RNC) and a media gateway (MGW) in a call setup procedure of a mobile communication network.

It is another object of the present invention to provide a system and method that can allow a mobile switching center (MSC) server to directly provide codec information to a media gateway (MGW) in a mobile communication network.

In accordance with one aspect of the present invention, the above and other objects can be accomplished by the provision of a method for providing codec information in a mobile communication network. The mobile communication network includes a radio network controller (RNC) of a radio access network accessed by at least one user equipment (UE), a media gateway (MGW) for connecting the RNC to another network, and a mobile switching center (MSC) server for controlling connections of the RNC and the MGW. The method comprises allowing the MSC server to determine the codec information for the UE through codec negotiation when the UE makes a call setup request; and allowing the MSC server to directly provide the determined codec information to the MGW, wherein the codec information is used when the MGW sets up a path associated with a requested call.

In accordance with another aspect of the present invention, the above and other objects can be accomplished by the provision of a mobile communication network. The mobile communication network comprises a radio network controller (RNC) of a radio access network accessed by at least one user equipment (UE); a media gateway (MGW) for connecting the RNC to another network; and a mobile switching center (MSC) server for controlling connections of the RNC and the MGW, determining the codec information for the UE through codec negotiation when the UE makes a call setup request, and directly providing the determined codec information to the MGW so that the codec information can be used when the MGW sets up a path associated with a requested call.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an International Mobile Telecommunications (IMT)-2000 network in accordance with an embodiment of the present invention;

FIG. 2 is a block diagram illustrating a configuration for setting up a call between user equipments (UEs) in the IMT-2000 network;

FIG. 3 is a block diagram illustrating a configuration for setting up a call between a UE and a fixed telephone in the IMT-2000 network;

FIG. 4 is a message flow chart illustrating a conventional codec negotiation procedure in a conventional IMT-2000 network;

FIG. 5 is a message flow chart illustrating a codec negotiation procedure in accordance with an embodiment of the present invention; and

FIG. 6 is a table illustrating a format of an additional request message provided from a mobile switching center (MSC) server to a media gateway (MGW) in accordance with an embodiment of the present invention.

Throughout the drawings, it should be noted that the same or similar elements are denoted by like reference numerals.

### DETAILED DESCRIPTION OF THE PREFERRED EMBODIMENTS

Embodiments of the present invention will be described in detail with reference to the accompanying drawings. In the following description, a detailed description of known functions and configurations incorporated herein will be omitted for conciseness. The words or expressions to be described below are defined on the basis of functions associated with embodiments of the present invention. The defined words or expressions can be changed according to the intentions or usual practices of a user or operator.

The present invention described below allows a mobile switching center (MSC) server to directly provide codec information to a media gateway in a circuit-switched (CS) mobile communication network.

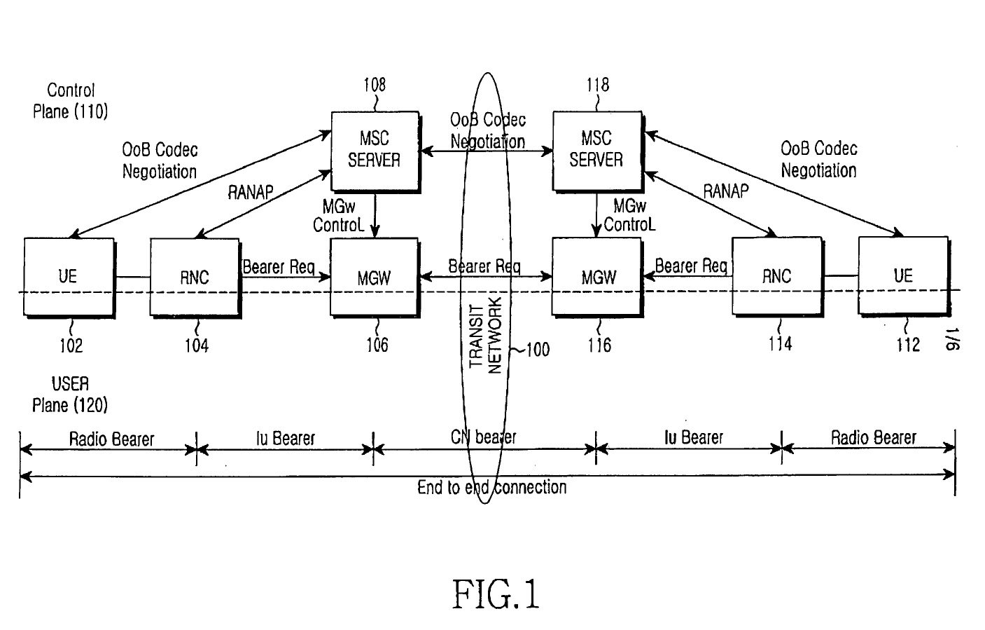

FIG. 1 is a block diagram illustrating an International Mobile Telecommunications (IMT)-2000 network in accordance with an embodiment of the present invention. Here, FIG. 1 shows a network of a Universal Mobile Telecommunications System (UMTS) called a wideband code division multiple access (WCDMA) system based on a global system for mobile communication (GSM) and general packet radio service (GPRS).

Referring to FIG. 1, a user equipment (UE) 102 of an originating side accesses a base station (not shown) called a Node B through a radio interface. The Node B couples signalling and user traffic from the UE 102 to a radio network controller (RNC) 104 of the originating side through an Iur interface (not shown). The RNC 104 is coupled to a transit network 100 via a media gateway (MGW) 106. The UE 102, the RNC 104 and the MGW 106 interconnect bearers also known as bearer channels necessary for call setup under the control of a mobile switching center (MSC) server 108 of the originating side.

A UE 112 of a terminating side is connected to an RNC 114 of the terminating side through a Node B (not shown), and the RNC 114 accesses the transit network 100 via an MGW 116. Similarly, the UE 112, the RNC 114 and the MGW 116 interconnect bearers necessary for call setup under the control of an MSC server 118.

A control plane 110 in the mobile communication network constructed as described above is associated with the mobile switching center (MSC) servers 108 and 118. A user plane (UP) 120 includes nodes 102, 104, 106, 116, 114 and 112 through which user traffic travels. Connections between the UEs 102 and 112 and the RNCs 104 and 114 are established by means of radio bearers, while connections between the RNCs 104 and 114 and the MGWs 106 and 116 are established through Iu bearers. Moreover, a connection between the MGWs 106 and 116 through the transit network 100 is established by a core network (CN) bearer. An end-to-end connection between the UEs 102 and 112 is established through the above-described bearers.

The MSC servers 108 and 118 provide codec information to the UEs 102 and 112 according to a result of out-of-band (OoB) codec negotiation, respectively. The MSC servers 108 and 118 provide radio bearer setup information and the codec information to the RNCs 104 and 114 through a radio access network application part (RANAP) protocol. The MSC servers 108 and 118 process the codec negotiation through an Nc interface (not shown). Moreover, the MSC servers 108 and 118 control the MGWs 106 and 116 using MGW control commands through MEGACO (Mc) interfaces (not shown) defined by the H.248 standard, respectively which is incorporated herein in its entirety.

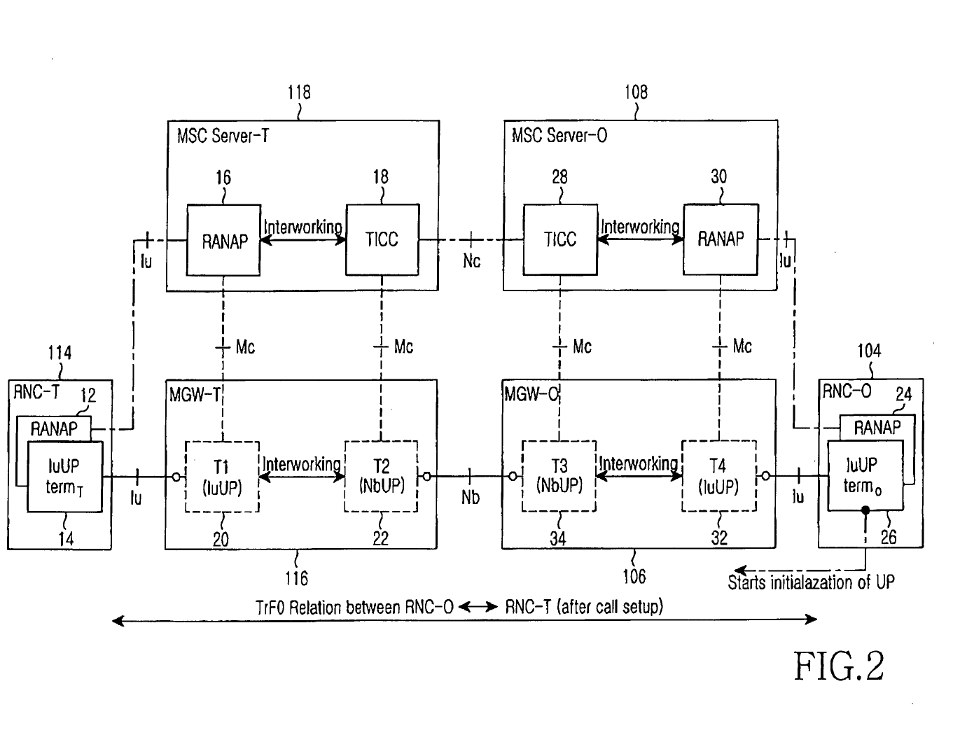

FIG. 2 shows a configuration for mobile-to-mobile call setup in the IMT-2000 network.

Referring to FIG. 2, radio network controllers (RNCs) 114 and 104 of the terminating and originating sides include radio access network application part (RANAP) entities 12 and 24 for Iu interfaces between the control plane and mobile switching center (MSC) servers 118 and 108 of the terminating and originating sides, and an Iu interface for user plane (IuUP) term_{T} 14 and an IuUP termₒ 26 for Iu interfaces between the user plane and the media gateways (MGWs) 116 and 106 of the terminating and originating sides. The MSC servers 118 and 108 include RANAP entities 16 and 30 for the Iu interfaces with the RNCs 114 and 104 and transport independent call control (TICC) entities 18 and 28 coupled to an Nc interface interworking with the RANAP entities 16 and 30.

Reference numeral 20 denotes T1 provided in the MGW 116 of the terminating side and serves as an IuUP point that is connected to the IuUP term_{T} 14 provided in the RNC 114 of the terminating side and is connected to the RANAP entity 16 provided in the MSC server 118 of the terminating side. Moreover, reference numeral 22 denotes T2 serving as an NbUP point that is connected to the TICC entity 18 provided in the MSC server 118 of the terminating side and the MGW 106 of the originating side. Similarly, reference numeral 32 denotes T4 provided in the MGW 106 of the originating side serving as an IuUP point that is connected to the IuUP termₒ 26 provided in the RNC 104 of the originating side and the RANAP entity 30 provided in the MSC server 108 of the originating side. Reference numeral 34 denotes T3 serving as an NbUP point that is connected to the TICC entity 28 provided in the MSC server 108 of the originating side and the MGW 116 of the terminating side.

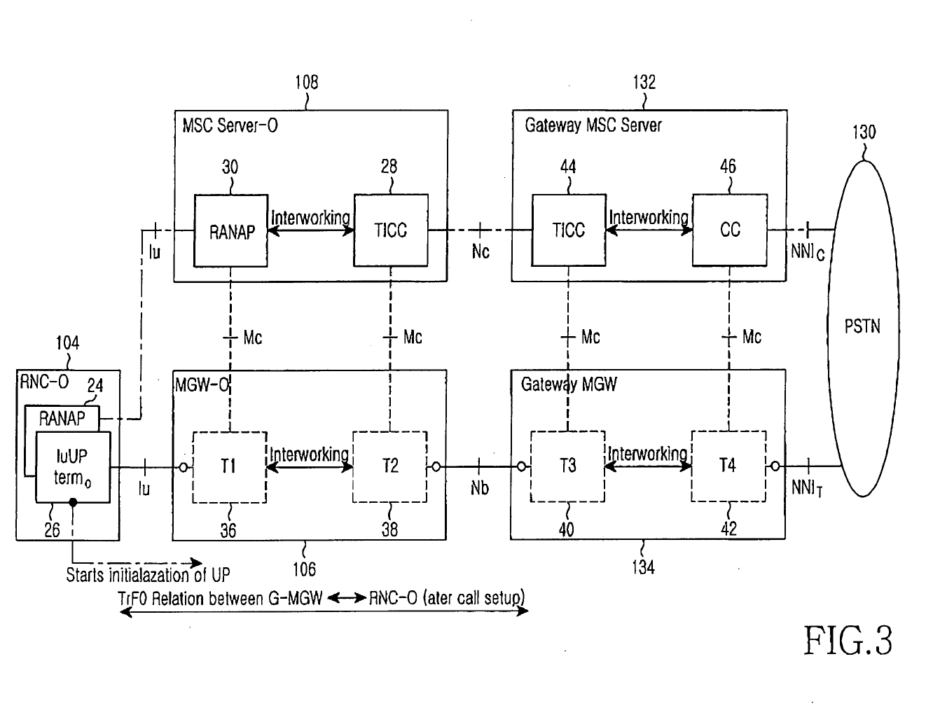

FIG. 3 shows a configuration for mobile-to-PSTN call setup between a UE and a fixed phone in the IMT-2000 network.

Referring to FIG. 3, a radio network controller (RNC) 104 of the originating side includes a radio access network application part (RANAP) entity 24 for an Iu interface between the control plane and a mobile switching center (MSC) server 108 of the originating side and an Iu interface for user plane (IuUP) termₒ 26 for an Iu interface between the user plane and a media gateway (MGW) 106 of the originating side. Moreover, the MSC server 108 of the originating side includes an RANAP entity 30 for an Iu interface with the RNC 104, and a transport independent call control (TICC) entity 28 coupled to an Nc interface for interworking with the RANAP entity 30.

Reference numeral 36 denotes T1 provided in the MGW 106 of the originating side serving as an IuUP point that is connected to the IuUP termₒ 26 provided in the RNC 104 of the originating side and the RANAP entity 30 provided in the MSC server 108 of the originating side. Moreover, reference numeral 38 denotes T2 serving as an NbUP point that is connected to the TICC entity 28 provided in the MSC server 108 of the originating side and the MGW 134 of the terminating side. Reference numeral 42 denotes T4 provided in the MGW 134 of the terminating side connected to a PSTN 130 serving as a point that is connected to the PSTN 130 and a call control (CC) entity 46 provided in an MSC server 132 of the terminating side. Reference numeral 40 denotes T3 serving as a point that is connected to a TICC entity 44 provided in a gateway MSC server 132 and the T2 38 provided in the MGW 106 of the originating side.

FIGS. 2 and 3 illustrate a configuration for allowing the UE 102 of the originating side to set up a call with the UE 112 associated with the different MSC server 118 and the configuration for allowing the UE 102 of the originating side to set up a call with the fixed phone belonging to the PSTN, respectively. However, the embodiments of the present invention are not limited to the above description. For example, the present invention can be easily applied to the case where the UE 102 of the originating side sets up a call with a UE of the terminating side belonging to the MSC server 118.

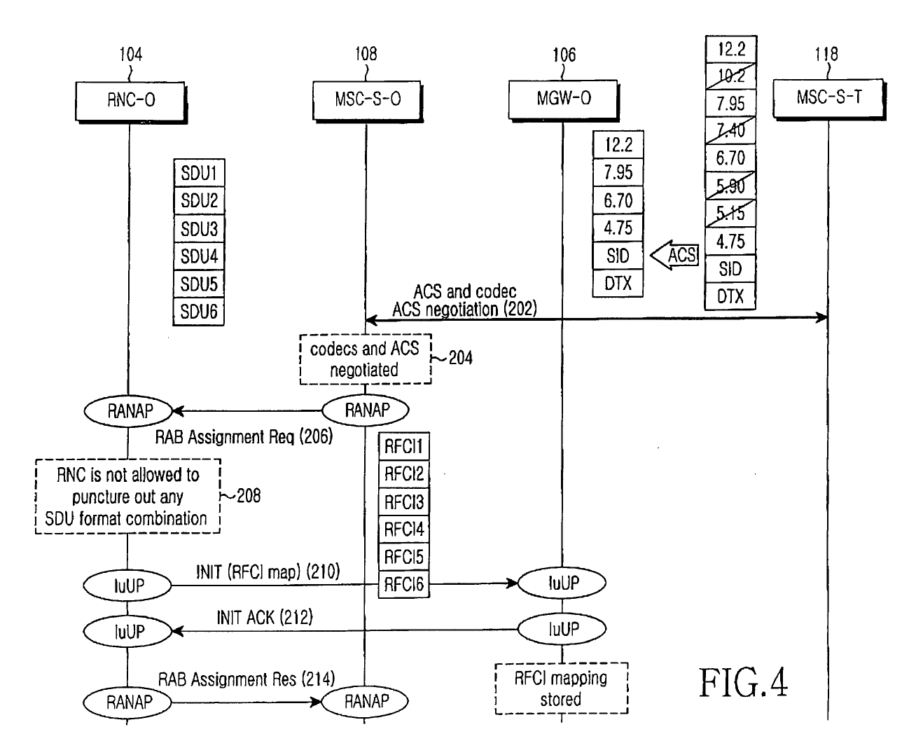

FIG. 4 is a message flow chart illustrating a conventional codec negotiation procedure in the typical IMT-2000 network. FIG. 4 illustrates a procedure for providing codec information determined by the codec negotiation procedure between the MSC server of the terminating side (MSC-S-T) 118 and the MSC server of the originating side (MSC-S-O) 108, and more particularly, a procedure for providing transmission rate information indicating a compression rate of voice traffic to the MGW of the originating side (MGW-O) 106 through the RNC of the originating side (RNC-O) 104.

When the UE of the originating side requests that the UE of the terminating side perform call setup at step 202 in FIG. 4, the MSC servers 108 and 118 of the originating and terminating sides determine an active codec set (ACS) including proper transmission rates through a mutual negotiation from a preset total transmission rate set. The ACS includes silence insertion descriptor (SID) and discontinuous transmission (DTX) information. Here, the decision of the ACS is made by various information units such as priorities of the UEs of the originating and terminating sides, a radio traffic state, and so on. Because the above-described information units are not directly associated with the present invention, a detailed description will be omitted.

At step 204, the MSC server 108 of the originating side processes the ACS and converts the ACS into service data units (SDUs) so that the ACS can be transmitted through an RANAP interface. The SDUs are transferred to the RNC 104 of the originating side through a radio access bearer (RAB) assignment request message based on an RANAP protocol at step 206. The RAB assignment request message further includes radio bearer (RB) information for radio bearer setup with the UE of the originating side.

At step 208, the RNC 104 of the originating side sets up a radio bearer with the UE of the originating side according to the RB information and the codec information, and generates a map of RAB subflow combination indicators (RFCIs) including the SDUs. At step 210, the RFCI map is transmitted to the MGW 106 of the originating side by an initialization (INIT) message through the IuUP interface.

At step 212, the MGW 106 of the originating side transmits an initialization acknowledgement message (INIT ACK) to the RNC 104 of the originating side, analyzes the RFCI map, extracts the codec information, and stores the extracted codec information. At step 214, the RNC 104 of the originating side confirms the initialization acknowledgement message and then transmits an RAB assignment response message to the MSC server 108 of the originating side.

The IuUP entity 20 provided in the MGW 106 of the originating side transfers the codec information to a call processor (not shown). The call processor performs a call processing operation using the codec information according to the Iu and CN bearer setup for a call-related connection. For example, the MGW 106 uses the codec information where transmitting guidance broadcast after an IuUP initialization operation is performed. Moreover, the MGW 106 uses the codec information when providing dual tone multi-frequency (DTMF) tones or other types of tones. For example, the MGW 106 internally stores the codec information acquired through the IuUP during call setup until a call is terminated. For this reason, a separate channel is needed when supplement services such as guidance broadcast in the course of communication, DTMF transmission, conference communication, call forwarding, call waiting, and so on are provided, and the codec information must be provided to a corresponding channel.

In the case of a bearer independent call control (BICC) call, the codec information uses an NbUP protocol so that it can be transferred from the MGW of the originating side to the MGW of the terminating side. That is, the codec information of the MGW of the originating side is transferred to the MGW of the terminating side through an Nb bearer. The codec information received by the MGW of the terminating side is employed as access information for the MGW of the terminating side.

Here, the BICC call refers to a call connected between different MSC servers. The codec information associated with the BICC call is provided to only the RNC. Because bearer setup operations are independently performed between the RNC and MGW, the MGWs, and the MGW and RNC, the codec information is exchanged through the IuUP initialization procedure. The RNC of the terminating side receives the codec information from the MSC server of the terminating side.

As shown in FIG. 4, there are problems in that additional resources are required so that a transmission operation can be performed between the RNC and the MGW where the codec information is provided to the MGW through the RNC, and an application is disabled in the case of a call between the UE and the fixed phone if the RNC is not provided. Thus, an embodiment of the present invention to be described below addresses the above-described problems by providing the MGW with codec information determined by codec negotiation between the MSC servers of the originating and terminating sides.

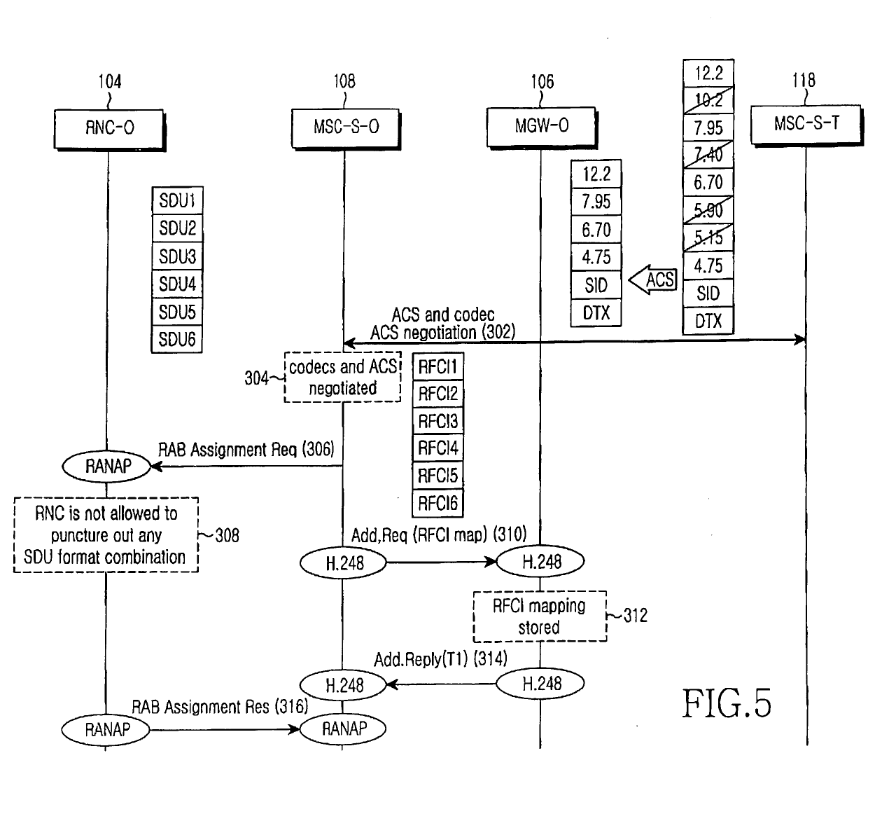

FIG. 5 is a message flow chart illustrating a codec negotiation procedure in accordance with an embodiment of the present invention. Here, codec information is directly provided to the MGW through a MEGACO (Mc) interface between the MSC server and MGW.

When the UE of the originating side requests that the UE of the terminating side perform a call setup at step 302 in FIG. 5, the MSC servers 108 and 118 of the originating and terminating sides determine an active codec set (ACS) including proper transmission rates from a preset total transmission rate set through mutual negotiation. The total transmission rate set includes possible transmission rates such as 12.2 Kbps, 10.2 Kbps, 7.95 Kbps, 7.40 Kbps, 6.70 Kbps, 5.90 Kbps, 5.15 Kbps and 4.75 Kbps, a silence insertion descriptor (SID) and discontinuous transmission (DTX) information. For example, the ACS includes 12.2 Kbps, 7.95 Kbps, 6.70 Kbps, 4.75 Kbps, SID and DTX information.

At step 304, the MSC server 108 of the originating side processes the ACS and converts the ACS into service data units (SDUs) so that the ACS can be transmitted through an RANAP interface. The SDUs are delivered to the RNC 104 of the originating side through a radio access bearer (RAB) assignment request message based on an RANAP protocol at step 306. The RAB assignment request message further includes radio bearer (RB) information for radio bearer setup with the UE of the originating side. At step 308, the RNC 104 of the originating side sets up a radio bearer with the UE of the originating side according to the RB information and the codec information.

At step 310, the MSC server 108 of the originating side processes the ACS, converts the ACS into a map of RAB subflow combination indicators (RFCIs), and transmits the RFCI map to the MGW 106 of the originating side through an additional request (Add. request) message based on the H.248 Megaco interface. The additional request message is used when the MSC server 108 of the originating side requests that the MGW 106 of the originating side perform a path setup with the MSC server 108 of the originating side.

At step 312, the MGW 106 of the originating side analyzes the RFCI map, extracts the codec information, stores the extracted codec information and sets up Iu and CN bearers according to a transmission rate indicated by the codec information. At step 314, the MGW 106 of the originating side transmits an additional reply (Add. reply) message based on the MEGACO interface corresponding to the additional request (Add. request) message to the MSC server 108 of the originating side. If so, the MSC server 108 of the originating side transfers an RAB assignment request message based on the RANAP interface to the RNC 104 at step 316.

The operations of respective nodes in accordance with an embodiment of the present invention will now be described. Specifically, the operations of the MSC server, RNC and MGW will be described.

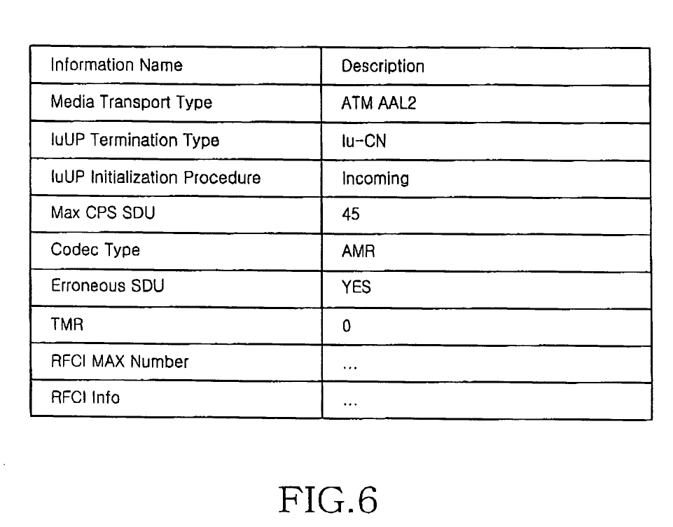

The MSC server transmits information other than the codec information, that is, radio bearer setup information, to the RNC through the RANAP. Moreover, the MSC server inserts the codec information into the additional request message to be transmitted to the MGW. FIG. 6 shows a format of the additional request message provided from the MSC server to the MGW in accordance with an embodiment of the present invention. Fields associated with the present invention relating to information fields of the additional request message shown in FIG. 6 will now be described.

A “Media Transport Type” field indicates a transport type, for example, an Asynchronous Transport Mode (ATM) ATM Adaptive Layer 2 (AAL2) for a voice call. An “IuUP Termination Type” field indicates a call termination type, for example, Iu-CN representing a termination call destined for a core network (CN). An “IuUP Initialization Procedure” field indicates whether or not an IuUP interface initialization procedure is incoming. A “Max CPS SDU” field indicates a maximum size of an SDU. The “Codec Type” field indicates a codec type, for example, adaptive multi-rate codec (AMR). An “Erroneous SDU” field indicates whether an error check of an SDU is used.

Where the MSC server provides the codec information only to the RNC according to the prior art, an additional request message transmitted to the MGW can include only the “Codec Type” field. However, in accordance with an embodiment of the present invention, the additional request message further includes an “RFCI Max Number” field and an “RFCI information” field as the codec information. Here, the “RFCI Max Number” field indicates the maximum RFCI value representing a possible maximum transmission rate in the total transmission rate set. In other words, the “RFCI Max Number” field indicates the number of subsequent RFCI information fields. The “RFCI information” field indicates information associated with an actual transmission rate, for example, a bit length of each subflow of an RFCI and the maximum bit length. The “RFCI information” field can indicate a minimum of 6 transmission rates and a maximum of 16 transmission rates according to a value of the “RFCI Max Number” field.

For example, where the value of the “RFCI Max Number” field is 6, the RFCI information is configured as in the following Table 1.

TABLE 1

| RFCI No. | Subflow 1 | Subflow 2 | Subflow 3 | Total length |
|---|---|---|---|---|
| 0 | 81 | 103 | 60 | 244 |
| 1 | 75 | 84 | 0 | 159 |
| 2 | 55 | 63 | 0 | 118 |
| 3 | 42 | 53 | 0 | 95 |
| 4 | 39 | 0 | 0 | 39 |
| 5 | 0 | 0 | 0 | 0 |

Upon receiving an RAB assignment request message from the MSC server, the RNC generates an IuUP initialization message according to the codec information included in the message, transmits the generated IuUP initialization (INIT) message to the MGW, and receives an initialization acknowledgement (INIT ACK) message from the MGW. The IuUP initialization (INIT) message does not include the codec information. That is, the codec information received by the RNC is only used when resources for path setup between the RNC and the MGW are assigned, and is not provided to the MGW. If the IuUP initialization operation has not been appropriately performed, the RNC re-transmits the IuUP initialization (INIT) message. Moreover, if the initialization acknowledgement (INIT ACK) message has not been received, a call is terminated as an abnormal call.

The MGW sets up a connection with the RNC, does not wait to receive the IuUP initialization (INIT) message, and sets up a path with the RNC and another gateway node using the codec information within the additional request message received from the MSC server. In the case of a BICC call, an initialization (INIT) message transmission procedure between the MGWs is removed. That is, an independent codec negotiation is carried out according to the signalling and bearer in case of the BICC call. However, the MSC server simultaneously provides the codec information to the RNC and the MGW, and an IuUP initialization (INIT) procedure between the RNCs and an NbUP initialization (INIT) procedure between the MGWs are removed, in accordance with an embodiment of the present invention. That is, the MGW node directly receives the codec information from the MSC server.

As apparent from the above description, embodiments of the present invention can provide the following advantages, among others:

1. As RFCI information is provided from the MSC server to the MGW for a PSTN outgoing call, negotiation for the codec information occurring before communication or in the course of communication can be ensured in advance.

2. As the control plane associated with signalling is responsible for an initialization procedure, the codec information can be transferred without setting up a bearer for the user plane. In particular, as an IuUP initialization procedure between the RNC and the MGW is removed and a bearer is set up in the call setup procedure, the system load can be reduced.

3. Because a path setup operation for a bearer connection needs to be performed in the course of a call setup procedure, delay due to IuUP initialization and NbUP initialization is removed. For example, because the MGW does not need to intervene in an IuUP and exchange an initialization (INIT) message in the case of a BICC call, system resources can be conserved and call setup time can be reduced.

Although embodiments of the present invention have been disclosed for illustrative purposes, those skilled in the art will appreciate that various modifications, additions and substitutions are possible, without departing from the scope of the invention. Therefore, the present invention is not limited to the above-described embodiments, but the present invention is defined by the claims which follow, along with their full scope of equivalents.

1. A method for providing codec information in a mobile communication network, the method comprising the steps of:
determining the codec information for a user equipment (UE) through codec negotiation via a mobile switching center (MSC) server when the UE makes a call setup request; and
directly providing the determined codec information to a mediga gateway (MGW) via the MSC server,
wherein the codec information is used when the MGW sets up a path associated with a requested call.

2. The method according to claim 1, further comprising the step of:
providing the determined codec information to a radio network controller (RNC) so that the determined codec information can be used when the RNC accessed by the UE sets up the path associated with the requested call.

3. The method according to claim 1, wherein the codec information is included in a control command, the control command being transferred from the MSC server to the MGW through a MEGACO interface.

4. The method according to claim 1, wherein the codec information is included in a message for requesting that the MGW perform a path setup operation, the message being transferred from the MSC server to the MGW.

5. The method according to claim 1, wherein the codec information is provided to the MGW in the format of radio access bearer (RAB) subflow combination indicator (RFCI) information for indicating at least one transmission rate assigned to the call.

6. A mobile communication network, comprising:
a radio network controller (RNC) of a radio access network accessed by at least one user equipment (UE);
a media gateway (MGW) for connecting the RNC to another network; and
a mobile switching center (MSC) server for controlling connections of the RNC and the MGW, determining the codec information for the UE through codec negotiation when the UE makes a call setup request, and directly providing the determined codec information to the MGW so that the codec information can be used when the MGW sets up a path associated with a requested call.

7. The mobile communication network according to claim 6, wherein the MSC server provides the determined codec information to the RNC so that the determined codec information can be used when the RNC accessed by the UE sets up the path associated with the requested call.

8. The mobile communication network according to claim 6, wherein the codec information is included in a control command, the control command being transferred from the MSC server to the MGW through a MEGACO interface.

9. The mobile communication network according to claim 6, wherein the codec information is included in a message for requesting that the MGW perform a path setup operation, the message being transferred from the MSC server to the MGW.

10. The mobile communication network according to claim 6, wherein the codec information is provided to the MGW in the format of radio access bearer (RAB) subflow combination indicator (RFCI) information for indicating at least one transmission rate assigned to the call.
